(19) United States
(12) Patent Application Publication
(10) Pub. No.: US 2010/0006798 A1
(43) Pub. Date: Jan. 14, 2010

(54) HEAT-CONDUCTIVE SILICONE COMPOSITION

(76) Inventor: Akihiro ENDO, Annaka-shi (JP)

Correspondence Address: BIRCH STEWART KOLASCH & BIRCH, PO BOX 747, FALLS CHURCH, VA, 22040-0747, US

(21) Appl. No.: 12/491,417

(22) Filed: Jun. 25, 2009

(30) Foreign Application Priority Data
Jul. 8, 2008 (JP) 2008-177757

(51) Int. Cl. C09K 5/00

(52) U.S. Cl. 252/78.3

(57) ABSTRACT

A heat-conductive silicone composition comprising (A) a silicone resin, (B) a heat-conductive filler, and (C) a volatile solvent is disposed between a heat-generating electronic part and a heat sink part. It is a grease-like composition at room temperature prior to application to the electronic or heat sink part. It becomes a non-flowable composition as the solvent volatilizes off after application, and this composition, when heated during operation of the electronic part, reduces its viscosity, softens or melts so that it may fill in between the electronic and heat sink parts.

### CROSS-REFERENCE TO RELATED APPLICATION

This non-provisional application claims priority under 35 U.S.C. §119(a) on Patent Application No. 2008-177757 filed in Japan on Jul. 8, 2008, the entire contents of which are hereby incorporated by reference.

### TECHNICAL FIELD

This invention relates to a heat-conductive silicone composition which is interposed at the thermal interface between a heat-generating electronic part and a heat-dissipating part such as a heat sink or metal housing for cooling the electronic part. More particularly, it relates to a heat-conductive silicone composition which becomes flowable at a temperature within the operating temperature range of the electronic part to enhance adhesion to the thermal interface for improving heat transfer from the electronic part to the heat-dissipating part.

### BACKGROUND ART

Circuit designs for modern electronic equipment such as televisions, DVD players, computers, medical instruments, business machines, communications equipment, and the like have become increasingly complex. For example, integrated circuits have been manufactured for these and other equipment which contain the equivalent of hundreds of thousands of transistors. While electronic equipment of smaller size and higher performance are desired, attempts have been continued to manufacture smaller electronic components and to pack more of these components in an ever smaller area. As a result, electronic parts generate more heat during operation. Since such heat can cause failure or malfunction, the mounting technology capable of effectively dissipating heat becomes crucial.

For removal of the heat generated by those electronic parts having a higher degree of integration such as CPU, driver IC and memories used in electronic equipment including personal computers, DVD players, and mobile phones, a number of heat-dissipating techniques have been proposed as well as heat-dissipating parts used therein.

One common approach taken in the prior art is direct heat transfer to heat sinks of high thermal conductivity metals such as aluminum, copper and brass. These heat sinks are adapted to conduct the heat generated by an electronic part and release the heat from their surface due to the temperature difference from the ambient atmosphere. For efficient transfer of heat from the electronic part to the heat sink, the heat sink must be brought in close contact with the electronic part without a gap. To this end, flexible low-hardness heat-conductive sheets or heat-conductive grease is interposed between the electronic part and the heat sink.

The low-hardness heat-conductive sheets are easy to handle and manipulate, but difficult to reduce in gage. Thick sheets cannot conform to fine irregularities on the surface of electronic parts and heat sinks, and such inconformity leads to a greater contact thermal resistance and hence, a failure of efficient heat transfer.

On the other hand, the heat-conductive grease can be applied thin so that the distance between the electronic part and the heat sink may be minimized. In addition, the grease fills in fine irregularities on the surface, facilitating a substantial reduction of thermal resistance. However, the grease has some problems including difficulty of handling, contamination of the surrounding, and losses of thermal properties due to oil bleeding by thermal cycling and pump-out (i.e., escape of grease out of the system).

As the heat-conductive member having both the advantages, the ease of handling of low-hardness heat-conductive sheets and the low thermal resistance of heat-conductive grease, a number of heat-softenable materials have recently been proposed which are solid and easy to handle at room temperature, but soften or melt by the heat generated by electronic parts.

JP-A 2000-509209 (WO 97/41599) discloses a heat-conductive material comprising an acrylic pressure-sensitive adhesive, an alpha-olefin thermoplasticizer, and a heat-conductive filler, or a paraffin wax and a heat-conductive filler. JP-A 2000-336279 describes a heat-conductive composition comprising a thermoplastic resin, wax, and a heat-conductive filler. U.S. Pat. No. 6,391,442 (JP-A 2001-89756) describes a thermal interface material comprising a polymer (e.g., acrylic resin), a low-melting component (e.g., C₁₂-C₁₆ alcohol or petroleum wax), and a heat-conductive filler. JP-A 2002-121332 describes a heat-softenable heat-dissipating sheet comprising a polyolefin and a heat-conductive filler.

Since all these materials are based on organic resins, they are not intended for flame retardance. When members of these materials are mounted on automobiles or the like, degradation at elevated temperatures is a matter of concern.

On the other hand, silicone is known as having excellent properties of heat resistance, weather resistance and flame retardance. A number of heat-softenable materials based on silicone have been proposed. JP-A 2000-327917 discloses a composition comprising a thermoplastic silicone resin, a wax-like modified silicone resin, and a heat-conductive filler. JP-A 2001-291807 discloses a heat-conductive sheet comprising a binder resin such as silicone gel, wax and a heat-conductive filler. JP-A 2002-234952 discloses a heat-softenable heat-dissipating sheet comprising a high molecular weight gel (e.g., silicone), a compound which becomes liquid upon heating (e.g., modified silicone or wax), and a heat-conductive filler.

Since these compositions use organic materials such as wax and modified silicone wax in addition to silicone, their flame retardance and heat resistance are inferior to those of silicone alone. While grease can be applied by automatic and mechanical means such as a dispenser or screen printing at a high mass-productivity, heat-softenable sheets are difficult to apply by automatic and mechanical means and inferior in mass-production efficiency.

Citation List

Patent Document 1: JP-A 2000-509209 (WO 97/41599)

Patent Document 2: JP-A 2000-336279

Patent Document 3: U.S. Pat. No. 6,391,442 (JP-A 2001-89756)

Patent Document 4: JP-A 2002-121332

Patent Document 5: JP-A 2000-327917

Patent Document 6: JP-A 2001-291807

Patent Document 7: JP-A 2002-234952

### SUMMARY OF INVENTION

An object of the invention is to provide a heat-conductive silicone composition which is improved in working efficiency, heat dissipation and reliability in that it is applicable by such techniques as dispensing and screen printing at a high mass-productivity, ensures good heat conduction and close contact and bond with heat-generating electronic parts and heat-dissipating parts, and is free of an oil bleeding or pump-out phenomenon.

The invention provides a heat-conductive silicone composition comprising (A) a silicone resin, (B) a heat-conductive filler, and (C) a volatile solvent in which these components are dissolvable or dispersible, for use as a heat-transfer material disposed between an electronic part adapted to generate heat to reach a temperature higher than room temperature during operation and a heat-dissipating part. The composition is a grease-like composition flowable at room temperature prior to application to the electronic or heat-dissipating part, but becomes a non-flowable, heat-softenable, heat-conductive composition as the solvent volatilizes off after application to the electronic or heat-dissipating part, and the latter composition, upon receipt of heat during operation of the electronic part, reduces its viscosity, softens or melts to render at least its surface flowable so that the composition may fill in between the electronic and heat-dissipating parts without a substantial gap.

In a preferred embodiment, component (A) comprises a polymer comprising R¹SiO_{3/2} units and/or SiO₂ units wherein R¹ is a substituted or unsubstituted, monovalent hydrocarbon group of 1 to 10 carbon atoms. The polymer may further comprise R¹₂SiO_{2/2} units wherein R¹ is as defined above.

In a preferred embodiment, component (A) is a silicone resin having a composition selected from formulae (i) to (iii):

DₘT^{Φ}ₚD^{Vi}ₙ (i)

wherein D is a dimethylsiloxane unit ((CH₃)₂SiO), T^{Φ} is a phenylsiloxane unit ((C₆H₅)SiO_{3/2}), D^{Vi} is a methylvinylsiloxane unit ((CH₃) (CH₂═CH)SiO), a molar ratio (m+n)/p=0.25 to 4.0, and molar ratio (m+n)/m=1.0 to 4.0,

M_{L}DₘT^{Φ}ₚD^{Vi}ₙ (ii)

wherein M is a trimethylsiloxane unit ((CH₃)₃SiO_{1/2}), D, T^{Φ}, and D^{Vi} are as defined above, a molar ratio (m+n)/p=0.25 to 4.0, molar ratio (m+n)/m=1.0 to 4.0, and molar ratio L/(m+n)=0.001 to 0.1, and

M_{L}DₘQ_{q}D^{Vi}ₙ (iii)

wherein Q is SiO_{4/2}, M, D and D^{Vi} are as defined above, a molar ratio (m+n)/q=0.25 to 4.0, molar ratio (m+n)/m=1.0 to 4.0, and molar ratio L/(m+n)=0.001 to 0.1.

In a preferred embodiment, the composition may further comprise (D-1) an alkoxysilane compound of the general formula (1):

R²ₐR³_{b}Si (OR⁴)_{4-a-b} (1)

wherein R² is independently alkyl of 6 to 15 carbon atoms, R³ is independently a substituted or unsubstituted, monovalent hydrocarbon group of 1 to 8 carbon atoms, R⁴ is independently alkyl of 1 to 6 carbon atoms, a is an integer of 1 to 3, b is an integer of 0 to 2, a+b is an integer of 1 to 3, and/or (D-2) a dimethylpolysiloxane capped with a trialkoxysilyl group at one end of its molecular chain, having the general formula (2):

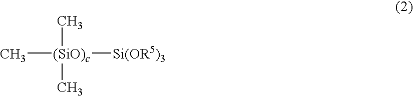

wherein R⁵ is independently alkyl of 1 to 6 carbon atoms, and c is an integer of 5 to 100, in an amount of 0.01 to 50 parts by volume per 100 parts by volume of component (A).

In a preferred embodiment, the composition may further comprise (E) an organopolysiloxane having a viscosity of 0.01 to 100 Pa-s at 25° C.

In preferred embodiments, the composition may have a viscosity of 10 to 500 Pa-s at 25° C. prior to volatilization of the solvent; a thermal conductivity of at least 0.5 W/m-K at 25° C. subsequent to volatilization of the solvent; and a viscosity of 10 to 1×10⁵ Pa-s at 80° C. subsequent to volatilization of the solvent.

In a preferred embodiment, the volatile solvent (C) comprises an isoparaffin solvent having a boiling point of 80 to 360° C.

In the disclosure, the heat-conductive silicone composition from which component (C) has volatilized off is sometimes referred to as “heat-softenable heat-conductive composition” or simply “heat-conductive composition.” A value in parts by volume of a material is equal to its mass divided by its theoretical specific gravity.

### BENEFITS OF THE INVENTION

The heat-conductive silicone composition prior to volatilization of the solvent is flowable at room temperature so that it is applicable by such techniques as dispensing or screen printing at a high efficiency of mass-production. Once the composition is applied to the heat-dissipating part, the composition becomes a non-flowable, heat-softenable heat-conductive composition as the solvent volatilizes off, thus preventing contamination of the surrounding environment by scattering. The heat-conductive composition is fully heat-conductive, and upon receipt of the heat generated by the electronic part during operation, reduces its viscosity, softens or melts to render at least its surface flowable so that any space between the electronic and heat-dissipating parts may be filled with the composition without a substantial gap. This achieves a close contact between the heat-generating electronic part and the heat-dissipating part. The substantial thickness of the composition between these parts can be reduced, and consequently, the thermal resistance therebetween can be significantly reduced. The interposition of the heat-conductive composition between the heat-generating electronic part and the heat-dissipating part ensures that the heat generated by the heat-generating electronic part is transferred to the heat-dissipating part for release. The heat-conductive silicone composition may be used for the purpose of heat release from general power supplies and electronic equipment, and heat release from LSI, CPU and other IC devices used in personal computers, digital video disk drives and other electronic equipment. The heat-conductive silicone composition is successful in significantly extending the lifetime of heat-generating electronic parts and electronic equipment having them built therein.

### DESCRIPTION OF EMBODIMENTS

### Component A

Component (A) is a silicone resin which forms a matrix of the heat-conductive silicone composition. Component (A) may be any silicone resin, provided that a heat-softenable heat-conductive composition that the heat-conductive silicone composition forms as the solvent volatilizes off is substantially solid or non-flowable at room temperature (e.g., 25° C.), but softens, reduces its viscosity or melts to be flowable at or above a certain temperature, preferably between 40° C. and the maximum ultimate temperature due to heat generation of the electronic part, specifically between 40° C. and 150° C., and more specifically between 40° C. and 120° C. Component (A) is a factor of causing the heat-softenable heat-conductive composition to undergo heat softening after solvent volatilization and plays the role of a binder of imparting workability and processability to the filler for imparting heat conduction to the silicone composition.

Since the heat softening, viscosity reducing or melting temperature refers to the temperature of the heat-softenable heat-conductive composition, the silicone resin itself may have a melting point of less than 40° C. Silicone resins may be used alone or in admixture of two or more as component (A).

The silicone resin as component (A) is not particularly limited as long as the above requirement is met. Silicone resins used as component (A) include polymers comprising R¹SiO_{3/2} units (referred to as T units) and/or SiO₂ units (referred to as Q units), and copolymers further comprising R¹₂SiO_{2/2} units (referred to as D units). To these polymers and copolymers, organopolysiloxanes having a backbone composed of D units, such as silicone oil and silicone gum may be added. Of these, combinations of silicone resins having a backbone composed of T and D units or silicone resins having a backbone composed of T units with organopolysiloxanes having a viscosity of 0.1 to 100 Pa-s at 25° C. as component (E) are preferred. The desired silicone resins as component (A) are blocked with a R¹₃SiO_{1/2} unit (referred to as M unit) at each end of the molecular chain and non-reactive. It is noted that the viscosity is measured and determined by the procedure according to JIS Z8803.

In the above units, R¹ stands for a substituted or unsubstituted monovalent hydrocarbon group of 1 to 10 carbon atoms, preferably 1 to 6 carbon atoms. Examples of R¹ include alkyl groups such as methyl, ethyl, propyl, isopropyl, butyl, isobutyl, tert-butyl, pentyl, neopentyl, hexyl, cyclohexyl, octyl, nonyl and decyl; aryl groups such as phenyl, tolyl, xylyl and naphthyl; aralkyl groups such as benzyl, phenylethyl and phenylpropyl; alkenyl groups such as vinyl, allyl, propenyl, isopropenyl, butenyl, hexenyl, cyclohexenyl, and octenyl; and substituted forms of the foregoing in which some or all hydrogen atoms are substituted by halogen atoms (e.g., fluoro, bromo, chloro), cyano groups or the like, such as chloromethyl, chloropropyl, bromoethyl, trifluoropropyl, and cyanoethyl. Inter alia, methyl, phenyl and vinyl are preferred.

The silicone resin as component (A) is described in further detail. The silicone resin used herein should comprise T units and/or Q units in order to be non-flowable at room temperature. Typical examples of the silicone resin include those comprising one or more of combinations of M and T units, combinations of D and T units, and combinations of M and Q units.

Introduction of T units is effective for enhancing toughness in order to improve brittleness in the solid state at room temperature for preventing any failure like cracks. Use of D units is also effective for improving toughness at room temperature. Thus, silicone resins of the preferred structure include silicone resins comprising a combination of M, T and D units, and silicone resins comprising a combination of M, Q and D units. Herein, the preferred substituent groups (R¹) on T units are methyl and phenyl; and the preferred substituent groups on D units are methyl, phenyl and vinyl. In the silicone resins comprising a combination of M, T and D units, a ratio of T units to D units is preferably from 10:90 to 90:10 and more preferably from 20:80 to 80:20 on a molar basis.

As mentioned above, introduction of D units is effective for improving the toughness of silicone resin in the solid state. In the other embodiment wherein the silicone resin as component (A) is one comprising M and T units, or M and Q units, it may be combined with an organopolysiloxane having a backbone composed mainly of D units, end-blocked with M unit and having a viscosity of 0.01 to 100 Pa-s at 25° C. as component (E), so as to enhance its toughness and mitigate its brittleness in the solid state. Specifically, in an example where component (A) is a silicone resin containing T units, but not D units, the organopolysiloxane (E) composed mainly of D units may be added thereto to form a composition having improved toughness. In this embodiment, the total of the silicone resin as component (A) and the organopolysiloxane also has a ratio of T units to D units preferably between 10:90 and 90:10, and more preferably between 20:80 and 80:20. The organopolysiloxane may be used alone or in admixture of two or more.

Examples of the organopolysiloxane (E) include oil and gum-like dimethylpolysiloxanes (silicone oil and silicone gum), and phenyl, polyether and phenyl polyether-modified polysiloxanes thereof.

In the embodiment wherein the organopolysiloxane (E) is added to the heat-conductive silicone composition to become a heat-softenable heat-conductive composition, the amount of the organopolysiloxane (E) added is preferably 1 to 100 parts by volume, and more preferably 20 to 50 parts by volume per 100 parts by volume of the silicone resin as component (A). The addition of organopolysiloxane in this range facilitates to improve the toughness of the resultant heat-softenable heat-conductive composition and to maintain the shape retention thereof.

As described above, it suffices that the silicone resin as component (A) undergo some decline of viscosity upon heating and serve as a binder for the heat-conductive filler. The silicone resin as component (A) preferably has a weight average molecular weight (Mw) of 500 to 20,000, and more preferably 1,000 to 10,000 as measured by gel permeation chromatography (GPC) versus polystyrene standards. Mw in this range ensures to maintain the viscosity of the resultant composition at an appropriate level upon heat softening, which facilitates to prevent pump-out upon thermal cycling (flow-out of base siloxane as a result of separation of filler and base siloxane, and flow-out of heat softened composition) and to maintain close contact with the electronic part or heat-dissipating part. It is noted that the silicone resin as component (A) advantageously imparts flexibility and tack to the heat-softenable heat-conductive composition. As component (A), a polymer having a single molecular weight or a mixture of two or more polymers having different molecular weight may be used.

Illustratively, examples of component (A) include silicone resins comprising difunctional structure units (D units) and trifunctional structure units (T units) in a specific composition as below.

DₘT^{Φ}ₚD^{Vi}ₙ (i)

Herein D is a dimethylsiloxane unit ((CH₃)₂SiO), T^{Φ} is a phenylsiloxane unit ((C₆H₅)SiO_{3/2}), D^{Vi} is a methylvinylsiloxane unit ((CH₃) (CH₂═CH) SiO), a molar ratio (m+n)/p is from 0.25 to 4.0, and a molar ratio (m+n)/m is from 1.0 to 4.0.

Also included are silicone resins comprising monofunctional structure units (M units), difunctional structure units (D units) and trifunctional structure units (T units) in a specific composition as below.

M_{L}DₘT^{Φ}ₚD^{Vi}ₙ (ii)

Herein M is a trimethylsiloxane unit ((CH₃)₃SiO_{1/2}), D, T^{Φ}, and D^{Vi} are as defined above, a molar ratio (m+n)/p is from 0.25 to 4.0, a molar ratio (m+n)/m is from 1.0 to 4.0, and a molar ratio L/(m+n) is from 0.001 to 0.1.

Further included are silicone resins comprising monofunctional structure units (M units), difunctional structure units (D units) and tetrafunctional structure units (Q units) in a specific composition as below.

M_{L}DₘQ_{q}D^{Vi}ₙ (iii)

Herein Q is SiO_{4/2}, M, D and D^{Vi} are as defined above, a molar ratio (m+n)/q is from 0.25 to 4.0, a molar ratio (m+n)/m is from 1.0 to 4.0, and a molar ratio L/(m+n) is from 0.001 to 0.1.

### Component B

Component (B) is a heat-conductive filler which is typically selected from metal powders, metal oxide powders and ceramic powders. Illustrative examples include aluminum powder, copper powder, silver powder, nickel powder, gold powder, aluminum oxide powder, zinc oxide powder, magnesium oxide powder, iron oxide powder, titanium oxide powder, zirconium oxide powder, aluminum nitride powder, boron nitride powder, silicon nitride powder, diamond powder, carbon powder, fullerene powder, carbon graphite powder, etc. The filler may be of any materials commonly used as the heat-conductive filler.

The heat-conductive filler which can be used herein has an average particle size of 0.1 to 100 μm, and preferably 0.5 to 50 μm. A particle size of less than 0.1 μm may lead to a viscosity buildup during loading and mixing and hence, inefficient working. Also, when the composition loaded with such fines becomes a heat-softenable heat-conductive composition after solvent volatilization, it may be more viscous upon heat pressing and provide a larger gap between the electronic part and the heat-dissipating part, which leads to greater thermal resistance and difficulty to develop a full heat-dissipation ability. The composition loaded with particles of more than 100 μm may have a lower viscosity upon working, but such larger particles may prevent the heat-softenable heat-conductive composition (when heat pressed) from being infiltrated into a gap of less than 100 μm between the electronic part and the heat-dissipating part, which leads to greater thermal resistance and difficulty to develop a full heat-dissipation ability. Accordingly, the average particle size is preferably in the range of 0.1 to 100 μm, with an average particle size of 0.5 to 50 μm being desired for meeting both flow and heat conduction.

The fillers may be used alone or in admixture. A mixture of two or more fractions of particles having different average particle size may also be used. It is noted that the average particle size refers to a volume average particle size as measured by a particle size distribution analyzer Microtrac® MT3300EX (Nikkiso Co., Ltd.).

The heat-conductive filler is compounded in an amount of 50 to 1,000 parts by volume, preferably 100 to 500 parts by volume per 100 parts by volume of component (A). The heat-conductive silicone composition loaded with too much amounts of the filler may lose flow prior to solvent volatilization and become difficult to apply, and may undergo unsatisfactory heat softening after solvent volatilization. The composition loaded with too less amounts of the filler may fail to provide the desired heat conduction.

### Component C

Component (C) is a volatile solvent in which components (A) and (B) are dissolvable or dispersible. In an embodiment wherein the heat-conductive silicone composition comprises other components in addition to components (A) and (B), it is preferred that the other components be also dissolvable or dispersible in the volatile solvent. Component (C) may be any solvent as long as components (A) and (B) and optionally, other components are dissolvable or dispersible therein. A single solvent or a mixture of two or more solvents may be used as component (C).

In general, heat-softenable heat-conductive compositions are non-flowable at room temperature and thus essentially impossible to apply by dispensing, screen printing or other techniques optimized for mass-productive application in a room temperature environment. The thermal conductivity of the composition is correlated to the percent loading of the heat-conductive filler so that the thermal conductivity is improved by increasing the loading of the heat-conductive filler. However, increasing the loading of the heat-conductive filler as a matter of course tends to cause a viscosity buildup to the heat-softenable heat-conductive composition, which becomes difficult to apply by dispensing, screen printing or other techniques optimized for mass-productive application, even at elevated temperatures. The composition is also increased in dilatancy when sheared. As discussed above, it was difficult in the prior art to apply heat-softenable compositions heavily loaded with a heat-conductive filler to heat-dissipating members such as heat sinks easily, uniformly and thinly by dispensing or screen printing. In the general procedure, heat-softenable compositions are formed into sheets, which are attached to heat-dissipating members such as heat sinks. However, this procedure is unamenable to automatic or machinery processing and difficult to increase the working efficiency.

In contrast, the heat-conductive silicone composition of the invention is grease-like and flowable prior to solvent volatilization, so that it is effectively applicable to heat-dissipating members such as heat sinks by dispensing or screen printing. After application, component (C) will readily volatilize at room temperature or be positively volatilized by heating. Thus, according to the invention, the heat-conductive silicone composition heavily loaded with a heat-conductive filler is applied to heat-dissipating members such as heat sinks by dispensing or screen printing and then component (C) is allowed or caused to volatilize, whereby the heat-softenable heat-conductive composition can be easily, uniformly and thinly provided. It is understood that the heat-conductive silicone composition may be applied to a heat-generating member such as a heat-generating electronic part instead of or along with the heat-dissipating member by dispensing or screen printing.

Component (C) preferably has a boiling point in the range of 80° C. to 360° C. A boiling point in this range ensures that the composition is kept applicable because sudden volatilization of component (C) from the composition during application working is restrained, which in turn prevents the composition from increasing its viscosity. In addition, once the composition is applied, least of component (C) remains in the composition, leading to an improvement in heat transfer.

Examples of component (C) include toluene, xylene, acetone, methyl ethyl ketone, cyclohexane, n-hexane, n-heptane, butanol, isopropanol (IPA), and isoparaffin solvents. For safety, health and working, isoparaffin solvents are preferred, with those isoparaffin solvents having a boiling point of 80° C. to 360° C. being most preferred.

When component (C) is added to the composition, the amount of component (C) is preferably up to 100 parts by volume and more preferably up to 50 parts by volume per 100 parts by volume of component (A). Amounts of component (C) within this range are effective in retarding precipitation of component (B) so that the composition is kept shelf stable. The lower limit is usually at least 0.1 part by volume although it may be selected as appropriate.

### Component D

In the preferred embodiment of the heat-conductive silicone composition, component (D) is further compounded as a surface treating agent for component (B).

### (D-1) Alkoxysilane

Included in component (D) is (D-1) an alkoxysilane compound of the general formula (1):

R²ₐR³_{b}Si (OR⁴)_{4-a-b} (1)

wherein R² is independently alkyl of 6 to 15 carbon atoms, R³ is independently a substituted or unsubstituted, monovalent hydrocarbon group of 1 to 8 carbon atoms, R⁴ is independently alkyl of 1 to 6 carbon atoms, a is an integer of 1 to 3, b is an integer of 0 to 2, and a+b is an integer of 1 to 3.

In formula (1), alkyl groups represented by R² include hexyl, octyl, nonyl, decyl, dodecyl and tetradecyl. As long as the alkyl groups represented by R² have 6 to 15 carbon atoms, component (B) is rendered more wettable, facilitating loading of component (B). In addition, the heat-conductive silicone composition becomes more efficient to handle and work, and is improved in low-temperature properties.

Suitable substituted or unsubstituted, monovalent hydrocarbon groups represented by R³ include alkyl groups such as methyl, ethyl, propyl, hexyl and octyl; cycloalkyl groups such as cyclopentyl and cyclohexyl; alkenyl groups such as vinyl and allyl; aryl groups such as phenyl and tolyl; aralkyl groups such as 2-phenylethyl and 2-methyl-2-phenylethyl; and halogenated hydrocarbon groups such as 3,3,3-trifluoropropyl, 2-(nonafluorobutyl)ethyl, 2-(heptadecafluorooctyl) ethyl and p-chlorophenyl. Inter alia, methyl and ethyl are preferred.

Suitable alkyl groups represented by R⁴ include methyl, ethyl, propyl, butyl, pentyl, and hexyl. Inter alia, methyl and ethyl are preferred.

Illustrative examples of component (D-1) are given below.

C₆H₁₃Si (OCH₃)₃

C₁₀H₂₁Si (OCH₃)₃

C₁₂H₂₅Si (OCH₃)₃

C₁₂H₂₅Si (OC₂H₅)₃

C₁₀H₂₁Si (CH₃) (OCH₃)₂

C₁₀H₂₁Si (C₆H₅) (OCH₃)₂

C₁₀H₂₁Si (CH₃) (OC₂H₅)₂

C₁₀H₂₁Si (CH═CH₂) (OCH₃)₂

C₁₀H₂₁Si (CH₂CH₂CF₃) (OCH₃)₂

As component (D-1), the foregoing alkoxysilanes may be used alone or in admixture. An appropriate amount of component (D-1) compounded is preferably 0.01 to 50 parts by volume, and more preferably 0.1 to 30 parts by volume per 100 parts by volume of component (A). Outside the range, larger amounts of component (D-1) may be uneconomical because of no further wetter effect, and a problem arises from some volatility of component (D-1) that the heat-conductive silicone composition and the heat-softenable heat-conductive composition thereof after solvent volatilization may gradually become brittle when held open to the atmosphere.

Also included in component (D) is (D-2) a dimethylpolysiloxane capped with a trialkoxysilyl group at one end of its molecular chain, having the general formula (2):

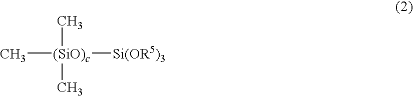

wherein R⁵ is independently alkyl of 1 to 6 carbon atoms, and c is an integer of 5 to 100. Compounding component (D-2) improves the compatibility of component (B) with component (A).

In formula (2), examples of the alkyl group represented by R⁵ are the same as the alkyl group of R⁴ in formula (1).

Illustrative examples of component (D-2) are given below.

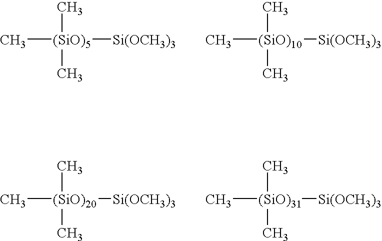

As component (D-2), the foregoing siloxanes may be used alone or in admixture. An appropriate amount of component (D-2) compounded is preferably 0.01 to 50 parts by volume, and more preferably 0.1 to 30 parts by volume per 100 parts by volume of component (A). With larger amounts of component (D-2) outside the range, the cured composition tends to have poor heat resistance and moisture resistance.

A combination of components (D-1) and (D-2) may also be used as component (D) or surface treating agent. In this embodiment, the total amount of component (D) compounded is preferably 0.02 to 50 parts by volume per 100 parts by volume of component (A)

### Other Additives

In the heat-conductive silicone composition, additives and fillers which are commonly used with synthetic rubbers may be optionally added as long as the objects of the invention are not impaired. Exemplary additives include silicone fluids and fluorine-modified silicone surfactants; colorants such as carbon black, titanium dioxide, and red iron oxide; and flame retardants such as platinum catalysts, metal oxides such as iron oxide, titanium oxide, and cerium oxide, and metal hydroxides. Also, finely divided silica such as precipitated silica or fired silica, and thixotropic agents may be added as an anti-settling agent for the heat-conductive filler. It is noted that the crosslinker or curing agent for crosslinking or curing component (A) is excluded in the inventive composition.

### Viscosity Prior to Solvent Volatilization

The heat-conductive silicone composition prior to solvent volatilization should preferably have a viscosity at 25° C. of 10 to 500 Pa-s, and more preferably 50 to 300 Pa-s, as measured by a rotational viscometer. With a viscosity of less than 10 Pa-s, component (B) is likely to settle down. The composition with a viscosity of more than 500 Pa-s may be less flowable, less effective to work by a dispensing or screen printing technique, and difficult to apply thinly to substrates.

### Thermal Conductivity Subsequent to Solvent Volatilization

The heat-softenable heat-conductive composition subsequent to solvent volatilization should preferably have a thermal conductivity of at least 0.5 W/m-K, specifically 0.5 to 10.0 W/m-K at 25° C. A thermal conductivity within this range ensures that the composition maintains effective heat transfer between the electronic part and the heat-dissipating part (e.g., heat sink), providing a high heat-dissipating capability.

### Viscosity Subsequent to Solvent Volatilization

The heat-softenable heat-conductive composition subsequent to solvent volatilization should preferably have a viscosity at 80° C. of 10 to 1×10⁵ Pa-s, and more preferably 50 to 5×10⁴ Pa-s. The heat-softenable heat-conductive composition with a viscosity within the range is unlikely to flow out between the electronic part and the heat-dissipating part (e.g., heat sink) and likely to reduce the space therebetween, providing a high heat-dissipating capability.

### Preparation of Composition

The heat-conductive silicone composition is prepared by mixing the above-mentioned components on a mixing device such as a dough mixer, kneader, gate mixer or planetary mixer. The composition thus prepared has an outstandingly improved thermal conductivity and is effectively workable, durable and reliable.

### Use of Composition

The heat-conductive silicone composition is applied to heat-generating or dissipating members. Exemplary heat-generating members include general power supplies; electronic equipment such as power transistors, power modules, thermistors, thermocouples, and temperature sensors; and heat-generating electronic parts such as LSI, CPU and other IC chips. Exemplary heat-dissipating members include heat-dissipating parts such as heat spreaders and heat sinks; heat pipes, and radiators. The composition can be readily applied by dispensing from a syringe or screen printing. For screen printing, a metal mask or screen mesh may be used, for example. Once the composition is applied to a heat-generating or dissipating member, the solvent is allowed or caused to volatilize off, whereby the heat-softenable heat-conductive composition is interposed between the heat-generating and dissipating members. When the electronic part generates heat during operation, the heat-softenable heat-conductive composition reduces its viscosity, softens or melts, thereby reducing the interfacial contact thermal resistance between the electronic part and the heat-dissipating part. The composition eventually provides a high heat-dissipating capability as well as improved flame retardance, heat resistance, and weather resistance. The composition is less liable to pumping-out as compared with grease-like compositions and remains reliable upon thermal cycling.

### Example

Examples of the invention are given below by way of illustration, but not by way of limitation.

First, the following components were provided before compositions were prepared therefrom.

### Component A

A-1: D₂₅T^{Φ}₅₅D^{Vi}₂₀ (weight average molecular weight 3300 versus polystyrene standards, softening point 40-50° C.) Herein D is a dimethylsiloxane unit ((CH₃)₂SiO),
T^{Φ} is a phenylsiloxane unit ((C₆H₅) SiO_{3/2}), and [[D^{Vi}]]
D^{Vi} is a methylvinylsiloxane unit ((CH₃) (CH₂═CH) SiO).
A-2: organopolysiloxane of the following compositional formula.

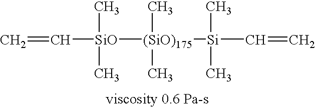

### Component B

B-1: aluminum powder (average particle size: 25.1 μm) theoretical specific gravity 2.70
B-2: aluminum powder (average particle size: 1.6 μm) theoretical specific gravity 2.70
B-3: zinc oxide powder (average particle size: 0.7 μm) theoretical specific gravity 5.67
B-4: aluminum oxide powder (average particle size: 10.1 μm) theoretical specific gravity 3.98

### Component C

C-1: Isozole® 400 (isoparaffin solvent, Nippon Oil Corp.), boiling point 210-254° C.
C-2: IP Solvent® 2835 (isoparaffin solvent, Idemitzu Kosan Co., Ltd.), boiling point 270-350° C.

### Component D

D-1: organosilane of the structural formula:

C₁₂H₂₅Si (OC₂H₅)₃
D-2: dimethylpolysiloxane capped with trimethoxysilyl at one end of the molecular chain, represented by the structural formula

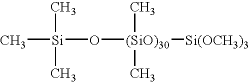

### Component E (Silicone Oil)

E-1: phenyl-containing silicone oil having a viscosity of 0.4 Pa-s at 25° C. (KF-54 by Shin-Etsu Chemical Co., Ltd.)

### Examples 1 to 3 and Comparative Examples 1 to 3

### Preparation of Heat-Conductive Silicone Compositions

Heat-conductive silicone compositions were prepared in accordance with the formulation shown in Table 1 by adding component (C) to component (A), optionally adding component (D) and other components, feeding them to a planetary mixer, agitating and mixing at 80° C. for 30 minutes to form a uniform solution. Component (B) was added to the uniform solution and agitated and mixed at room temperature for one hour.

### Applicability of Heat-Conductive Silicone Compositions

A stainless steel (SUS) plate dimensioned 3 cm×3 cm×120 ηm was provided as a metal screen. Using a squeezer in combination with the metal screen, the heat-conductive silicone composition was applied to a heat sink. The composition was evaluated whether or not it could be applied at 25° C. The composition was rated good (◯) when it could be uniformly applied over the entire surface and poor (×) when it could not be applied. The results are shown in Table 1.

### Thermal Conductivity of Heat-Softenable Heat-Conductive Composition Subsequent to Solvent Volatilization

The heat-softenable heat-conductive composition subsequent to solvent volatilization was sandwiched between two standard aluminum disks (purity 99.99%, diameter about 12.7 mm, thickness about 1.0 mm). The assembly was compressed while heating by a dryer. The substantial thickness of the heat-softenable heat-conductive composition was determined by measuring the thickness of the overall assembly and subtracting therefrom the sum of the given thicknesses of standard aluminum disks. In this way, a series of samples of the heat-softenable heat-conductive composition having different thickness were prepared. The samples were measured for thermal resistance (unit: mm-²-K/W) at 25° C. by a thermal diffusivity meter (xenon flash analyzer LFA447 NanoFlash by Netzsch) in accordance with the laser flash method. A chart was drawn by plotting thermal resistance values relative to thickness, and a thermal conductivity was computed as the reciprocal of the gradient of the chart. Note that for thickness measurement, a micrometer model M820-25VA (Mitutoyo Corp.) was used. The results are shown in Table 1.

### Viscosity of Heat-Softenable Heat-Conductive Composition Subsequent to Solvent Volatilization

The heat-softenable heat-conductive composition subsequent to solvent volatilization was measured for viscosity at 80° C. by a dynamic viscoelasticity meter RDA3 (TA Instruments). The results are shown in Table 1.

TABLE 1

| | | | Example | | | Comparative Example | | |
|---|---|---|---|---|---|---|---|---|
| | | | 1 | 2 | 3 | 1*¹⁾ | 2*²⁾ | 3 |
| Formulation | (A) | A-1 | 100.0 | 100.0 | 100.0 | 100.0 | 100.0 | — |
| (parts by | | A-2 | — | — | — | — | — | 100.0 |
| volume) | (B) | B-1 | 166.7 | 148.1 | — | 166.7 | — | 166.7 |
| | | B-2 | 111.1 | 98.8 | — | 111.1 | — | 111.1 |
| | | B-3 | 30.9 | 26.5 | 35.3 | 30.9 | — | 30.9 |
| | | B-4 | — | — | 301.5 | — | — | — |
| | (C) | C-1 | 30.0 | 30.0 | — | — | — | 30.0 |
| | | C-2 | — | — | 35.0 | — | — | — |
| | (D) | D-1 | 6.0 | — | 7.5 | 6.0 | — | 6.0 |
| | | D-2 | — | 10.0 | — | — | — | — |
| | (E) | E-1 | 20.0 | — | 20.0 | — | 20.0 | 10.0 |

| | | | | | | |
|---|---|---|---|---|---|---|
| Viscosity of | 115 | 182 | 163 | non-flowable, | 0.6 | 53 |
| heat-conductive | | | | unmeasurable | | |
| silicone | | | | | | |
| composition | | | | | | |
| (Pa-s) | | | | | | |
| Applicability of | ◯ | ◯ | ◯ | X | ◯ | ◯ |
| heat-conductive | | | | | | |
| silicone | | | | | | |
| composition | | | | | | |
| Thermal | 3.2 | 3.3 | 3.0 | 4.0 | 0.2 | 3.1 |
| conductivity of | | | | | | |
| heat-softenable | | | | | | |
| heat-conductive | | | | | | |
| composition | | | | | | |
| (W/m-K) | | | | | | |
| Viscosity of | 2600 | 7600 | 6600 | 8900 | not | flowable |
| heat-softenable | | | | | tested | at RT |
| heat-conductive | | | | | | |
| composition | | | | | | |
| (Pa-s) | | | | | | |

¹⁾Since the composition of Comparative Example 1 did not become paste even after agitation and mixing on a mixer at room temperature, agitation was performed at 80° C.
²⁾The composition of Comparative Example 2 was shelf unstable as oil separation occurred.

Japanese Patent Application No. 2008-177757 is incorporated herein by reference.

Although some preferred embodiments have been described, many modifications and variations may be made thereto in light of the above teachings. It is therefore to be understood that the invention may be practiced otherwise than as specifically described without departing from the scope of the appended claims.

1. A heat-conductive silicone composition comprising (A) a silicone resin, (B) a heat-conductive filler, and (C) a volatile solvent in which these components are dissolvable or dispersible, for use as a heat-transfer material disposed between an electronic part adapted to generate heat to reach a temperature higher than room temperature during operation and a heat-dissipating part, wherein
the composition is a grease-like composition flowable at room temperature prior to application to the electronic or heat-dissipating part, but becomes a non-flowable, heat-softenable, heat-conductive composition as the solvent volatilizes off after application to the electronic or heat-dissipating part, and the latter composition, upon receipt of heat during operation of the electronic part, reduces its viscosity, softens or melts to render at least its surface flowable so that the composition may fill in between the electronic and heat-dissipating parts without a substantial gap.

2. The composition of claim 1 wherein component (A) comprises a polymer comprising R¹SiO_{3/2} units and/or SiO₂ units wherein R¹ is a substituted or unsubstituted, monovalent hydrocarbon group of 1 to 10 carbon atoms.

3. The composition of claim 2 wherein the polymer further comprises R¹₂SiO_{2/2} units wherein R¹ is a substituted or unsubstituted, monovalent hydrocarbon group of 1 to 10 carbon atoms.

4. The composition of claim 1 wherein component (A) is a silicone resin having a composition selected from formulae (i) to (iii):
DₘT^{Φ}ₚD^{Vi}ₙ (i)
wherein D is a dimethylsiloxane unit ((CH₃)₂SiO), T^{Φ} is a phenylsiloxane unit ((C₆H₅)SiO_{3/2}), D^{Vi} is a methylvinylsiloxane unit ((CH₃)(CH₂═CH)SiO), a molar ratio (m+n)/p=0.25 to 4.0, and molar ratio (m+n)/m=1.0 to 4.0,
M_{L}DₘT^{Φ}ₚD^{Vi}ₙ (ii)
wherein M is a trimethylsiloxane unit ((CH₃)₃SiO_{1/2}), D, T^{Φ}, and D^{Vi} are as defined above, a molar ratio (m+n)/p=0.25 to 4.0, molar ratio (m+n)/m =1.0 to 4.0, and molar ratio L/(m+n)=0.001 to 0.1, and
M_{L}DₘQ_{q}D^{Vi}ₙ
(iii)
wherein Q is SiO_{4/2}, M, D and D^{Vi} are as defined above, a molar ratio (m+n)/q=0.25 to 4.0, molar ratio (m+n)/m=1.0 to 4.0, and molar ratio L/(m+n)=0.001 to 0.1.

5. The composition of claim 1, further comprising (D-1) an alkoxysilane compound of the general formula (1):
R²ₐR³_{b}Si(OR⁴)_{4-a-b} (1)
wherein R² is independently alkyl of 6 to 15 carbon atoms, R³ is independently a substituted or unsubstituted, monovalent hydrocarbon group of 1 to 8 carbon atoms, R⁴ is independently alkyl of 1 to 6 carbon atoms, a is an integer of 1 to 3, b is an integer of 0 to 2, a+b is an integer of 1 to 3, and/or (D-2) a dimethylpolysiloxane capped with a trialkoxysilyl group at one end of its molecular chain, having the general formula (2): 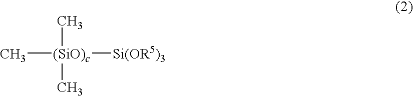
wherein R⁵ is independently alkyl of 1 to 6 carbon atoms, and c is an integer of 5 to 100, in an amount of 0.01 to 50 parts by volume per 100 parts by volume of component (A).

6. The composition of claim 1, further comprising (E) an organopolysiloxane having a viscosity of 0.01 to 100 Pa-s at 25° C.

7. The composition of claim 1, having a viscosity of 10 to 500 Pa-s at 25° C. prior to volatilization of the solvent.

8. The composition of claim 1, having a thermal conductivity of at least 0.5 W/m-K at 25° C. subsequent to volatilization of the solvent.

9. The composition of claim 1, having a viscosity of 10 to 1×10⁵ Pa-s at 80° C. subsequent to volatilization of the solvent.

10. The composition of claim 1, wherein the volatile solvent (C) comprises an isoparaffin solvent having a boiling point of 80 to 360° C.
